(19) United States
(12) Patent Application Publication
(10) Pub. No.: US 2026/0322489 A1
(43) Pub. Date: Oct. 15, 2026

(54) PATTERN AND TREND IDENTIFICATION IN FIBER SENSING IN AN OPTICAL NETWORK

(71) Applicant: Nokia Solutions and Networks Oy, Espoo (FI)

(72) Inventors: Srinivasan NANGAVARAM, Murray Hill, NJ (US); Ajay MALIK, Campbell, CA (US); Narendra RATH, Bangalore (IN)

(21) Appl. No.: 19/643,361

(22) Filed: Apr. 9, 2026

(30) Foreign Application Priority Data
Apr. 9, 2025 (IN) 202511034767

(51) Int. Cl. H04B 10/079; G01J 4/04; G06F 18/22; G06F 123/02

(52) U.S. Cl. CPC H04B 10/0793; G01J 4/04; G06F 18/22; H04B 10/0795; G06F 2123/02

(57) ABSTRACT

A pattern and trend identification in fiber sensing in an optical network is disclosed for providing early warnings of developing problems in fiber optic networks. The pattern and trend identification in fiber sensing in an optical network includes obtaining a sample of a recent time-series of Stokes vector data from a subset of collection points in the optical network; determining a respective polarization signature from each of said time-series; comparing the samples to a repository of known Stokes vector data signatures; and raising an alarm when at least one of said recent time-series sufficiently corresponds to a signature in the repository. The pattern and trend identification in fiber sensing in an optical network is particularly useful for overcoming limited sensitivity to subtle disturbances of pattern and trend identification known in the art.

### BACKGROUND

### Technical Field

Various example embodiments relate to pattern and trend identification in fiber sensing in an optical network and are particularly concerned with detecting patterns that indicate potential disturbances before they cause service disruption.

### Background

This section introduces aspects that may help facilitate a better understanding of the disclosure. Accordingly, the statements of this section are to be read in this light and are not to be understood as admissions about what is prior art or what is not prior art.

Fiber optic networks form the backbone of modern telecommunications infrastructure, carrying vast amounts of data across long distances. These networks are susceptible to various external disturbances, from construction activities to environmental factors, which can cause signal degradation or even fiber breaks. Conventional monitoring solutions typically detect problems only after they’ve occurred, leading to service interruptions and costly repairs.

Current optical network monitoring typically relies on Optical Time Domain Reflectometry (OTDR), which can detect major fiber breaks, or distributed Acoustic Sensing (DAS), which can detect vibrations along a fiber. However, OTDR can have limited sensitivity to subtle disturbances and DAS systems typically require deployment of specialized equipment beyond that of standard optical switches.

Thus, a need exists for a network monitoring solution that can provide early warning of developing problems in a fiber optic system. There is a further need for a network monitoring solution that operates in a proactive mode, detecting issues before they begin to impact service quality and then providing early warnings of any developing problems.

### SUMMARY

According to an aspect of the present disclosure there is provided a method for pattern and trend identification in fiber sensing in an optical network having the steps of: obtaining a sample of a recent time-series of Stokes vector data from a subset of collection points in the optical network; determining a respective polarization signature from each of said time-series; comparing the samples to a repository of known Stokes vector data signatures; and raising an alarm when at least one of said recent time-series sufficiently corresponds to a signature in the repository.

Advantages of the present disclosure include early warnings of developing problems in fiber optic systems.

Conveniently, in some embodiments, the subset corresponds to a single sampling point in the optical network.

In some embodiments, the determining step uses geometric properties of the time-series trajectory.

In some of these embodiments, the geometric properties are at least one of arc length, curvature, and torsion.

According to other embodiments, the comparing step uses multi-resolution signal processing.

In some of these embodiments, the multi-resolution signal processing are at least of one of wavelet transform analysis, non-linear dynamics analysis, and information-theoretic measure assessment.

In other of these embodiments, the comparing step uses temporal-trend analysis processing.

In some of these embodiments, the temporal-trend analysis processing uses at least of one of sequence analysis methods, trend detection methods, early warning indicator methods, and multivariate trend analysis.

In other embodiments, the subset of collection points has multiple monitoring points within the optical network topology, each collection point having a respective Stokes vector time-series captured.

In some of these embodiments, there is a correlating step of the respective signatures to generate a composite signature representative of disturbances of the optical network over more than one sample point.

In some of these embodiments, the correlating step is at least one of light-speed delay analysis, differential pattern analysis, signal strength triangulation, timing-based analysis, and propagation models analysis.

In other embodiments, there is the additional step of providing said repository with signatures flagged as disturbance precursor indicators by a pattern learning and matching system.

In some of these embodiments, the providing step uses application of at least one of Bayesian methods, one-shot/few-shot learning adaptation methods, and knowledge-based feature engineering methods.

In others of these embodiments, the providing step uses application of at least one of using physics-informed signal processing, using domain knowledge, implementing rule-based detection for well-understood pattern types, selectively incorporating machine learning, and combining analytical models with data-driven components.

In others of these embodiments, the providing step uses application of at least one of using physics-informed signal processing, using high-fidelity physical simulations of polarization effects for different disturbance types, training initial models on simulated data, fine-tuning pre-trained models with the available real-world data, and using domain adaptation techniques to bridge the gap between simulation and reality.

In accordance with another aspect of the present disclosure, there is provided a disturbance alerting manager for pattern and trend identification in fiber sensing in an optical network, the disturbance alerting manager having: at least one processor; and at least one memory storing instructions that, upon being executed by the at least one processor, cause the disturbance alerting manager at least to: obtain a sample of a recent time-series of Stokes vector data from a subset of collection points in the optical network; determine respective polarization signature from each of said time-series; compare the samples to a repository of known Stokes vector data signatures; and raise an alarm when at least one of said recent time-series sufficiently corresponds to a signature in the repository.

In some of these embodiments, the subset corresponds to a single sampling point in the optical network.

### BRIEF DESCRIPTION OF THE DRAWINGS

Embodiments of the disclosure will become more fully apparent from the following detailed description, the appended claims, and the accompanying drawings in which like reference numerals identify similar or identical elements

FIG. 1 depicts a representation of a Poincaré sphere having a Stokes vector depicted on the sphere in accordance with an embodiment of the present disclosure; and

FIG. 2 depicts a representation of a Poincaré sphere having a pair of Stokes vectors representing the polarization state of a sample point at two different points in time in accordance with an embodiment of the present disclosure.

FIG. 3 depicts a structural block diagram of system components for pattern and trend identification in fiber sensing in an optical network in accordance with an embodiment of the present disclosure.

FIG. 4 depicts an example embodiment of a method for stocking a polarization signature repository in accordance with an embodiment of the present disclosure.

FIG. 5 depicts an example embodiment of a method for handing a polarization signature-based alarm raising at a network management alarm system in accordance with an embodiment of the present disclosure.

FIG. 6 depicts an example embodiment of a computer suitable for use in performing various functions presented herein.

### DETAILED DESCRIPTION

Detailed illustrative embodiments of the present disclosure are provided herein. However, specific structural and functional details disclosed herein are merely representative for purposes of describing example embodiments of the present disclosure. The present disclosure may be embodied in many alternate forms and should not be construed as limited to only the embodiments set forth herein. Further, the terminology used herein is for the purpose of describing particular embodiments only and is not intended to be limiting of example embodiments of the disclosure.

As used herein, the singular forms "a," "an," and "the," are intended to include the plural forms as well, unless the context clearly indicates otherwise. It further will be understood that the terms "comprises," "comprising," "contains," "containing," "includes," and/or "including," specify the presence of stated features, steps, or components, but do not preclude the presence or addition of one or more other features, steps, or components. It also should be noted that in some alternative implementations, the functions/acts noted may occur out of the order noted in the figures. For example, two figures shown in succession may in fact be executed substantially concurrently or may sometimes be executed in the reverse order, depending upon the functions/acts involved.

Stokes parameters are a set of values that describe the polarization state of electromagnetic radiation. A “Stokes 4-vector” refers to a four-component vector comprised of the four Stokes parameters (S0, S1, S2, S3); “Stokes 3-vector” and “Stokes vector” both refer to a vector comprised of three Stokes parameters (S1, S2, S3), or to a unit vector with the same direction, as will be clear from the context.

“Stokes space” is a three-dimensional space in which each point corresponds to a Stokes 3-vector. The locus of all unit vectors in Stokes space is commonly referred to as the Poincaré sphere. It is common to graphically represent a pure polarization state, or the polarized part of a partially-polarized polarization state, by its unit Stokes vector, shown as a point on the surface of the Poincaré sphere.

Some optical switches include the capability to measure Stokes vectors at either end of fiber connections, providing fundamental polarization data. However, existing polarization monitoring approaches typically focus on detecting and compensating for polarization mode dispersion rather than using polarization data for external disturbance detection.

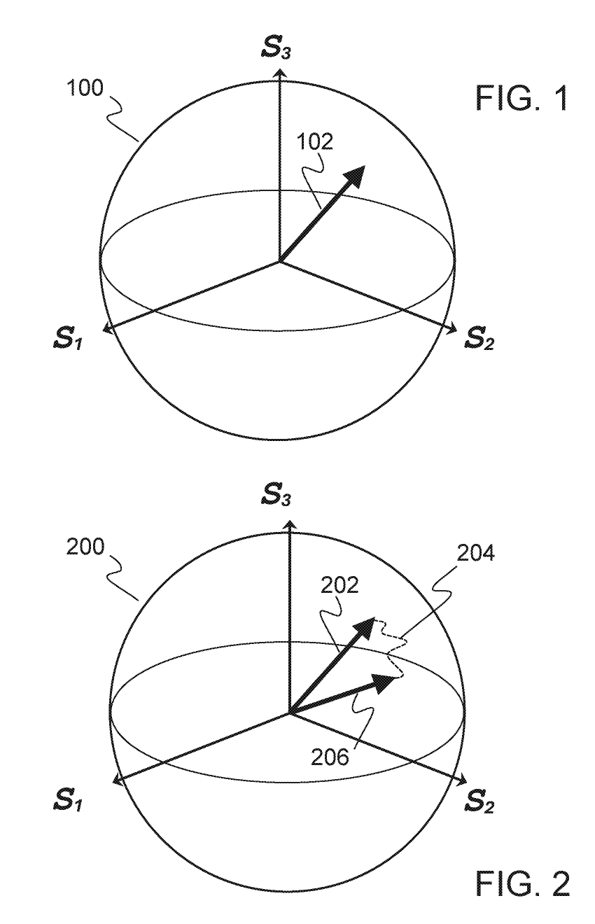

Referring to FIG. 1, there may be seen a representation of a Poincaré sphere 100, having three-dimensional Cartesian coordinates S₁, S₂, and S₃ axes, and a representative Stokes vector (Stokes 3- vector) 102 plotted on the Poincaré sphere 100 representing a particular polarization state, measured for example at the end of a fiber optic cable.

The polarization state, as measured at a sampling point, may vary with time due to disturbances of the fiber optic cable or associated hardware.

Referring to FIG. 2, there may be seen a representation of a Poincaré sphere 200, having three-dimensional Cartesian coordinates S₁, S₂, and S₃ axes as in FIG. 1 with a Stokes vector 202. Over time, as the measured polarization state of the sampling point changes, the Stokes vector corresponding to the polarization state of the sampling point traces a path or trajectory 204 along the surface of the Poincaré sphere 200 and arrives at a polarization state corresponding to Stokes vector 206.

The trajectory 204 may possess distinguishing characteristics which can be used to detect and identify patterns that indicate developments and potential disturbances before they cause service disruption. Analysis of these distinguishing characteristics may identify unique "fingerprints" for different disturbance types, and these fingerprints may be used to diagnose and warn of ongoing developments occurring in the optical network of which the sampling point is a part.

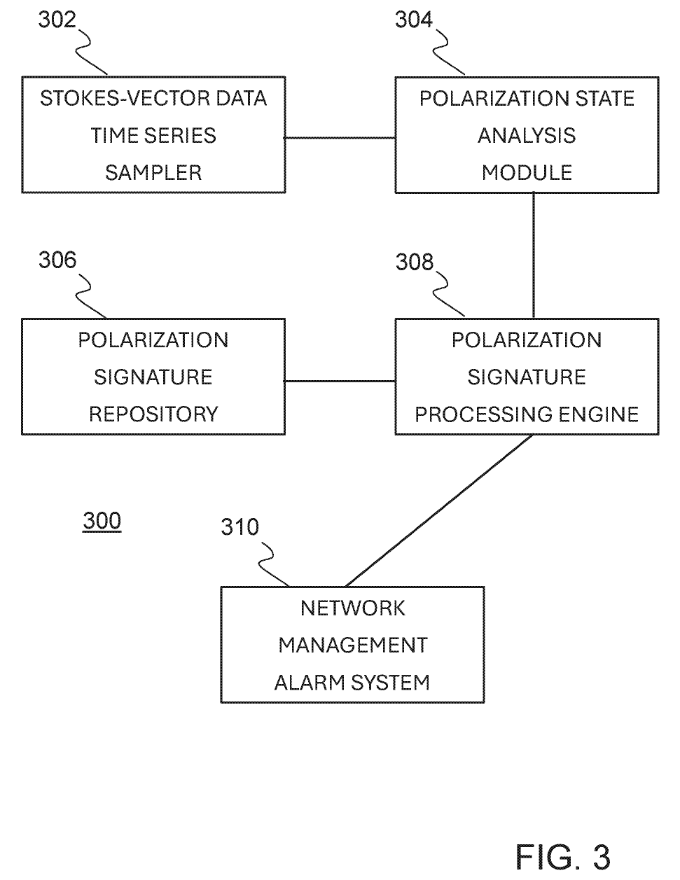

Referring to FIG. 3, there may be seen a block diagram of an embodiment of the disclosure. Stokes vector data time-series sampler 302 collects polarization data at a sample point in an optical network. The Stokes vector time-series samples are sent to a polarization state analysis module 304 which processes raw Stokes vector time-series data (S1, S2, S3) to track complete trajectories on the Poincaré sphere for the particular time-series. This is effected by calculating key geometric properties:
Arc length: The total path traveled by the state of polarization, indicating overall polarization volatility.
Curvature: How sharply the path bends, revealing rapid changes in polarization direction.
Torsion: How the path twists in 3D space, capturing complex polarization dynamics.

These properties form a unique "polarization fingerprint" for different types of disturbances. For example, vibrations from construction equipment produce high-frequency oscillatory patterns with distinct curvature profiles, while temperature changes cause gradual shifts with minimal torsion. This trajectory-based approach captures dynamic signatures that simple threshold-based methods miss entirely.

The characterized polarization fingerprint is then passed to the multi-resolution polarization signature processing engine 308. The engine 308 enables detection of disturbance signatures that would be invisible to conventional monitoring systems relying on simple threshold crossings or basic statistical measures. This is accomplished by using:
Wavelet transform analysis to detect patterns at multiple time scales simultaneously, enabling identification of both rapid transient events (seconds to minutes) and slower evolving disturbances (hours to days).
Non-linear dynamics analysis to extract features like Lyapunov exponents and recurrence quantification metrics that characterize the complexity and predictability of polarization changes.
Information-theoretic measures to calculate entropy rates and mutual information between Stokes parameters and to reveal subtle dependencies that indicate specific disturbance types.

The resulting polarization fingerprint is compared to previously characterized polarization fingerprints stored in polarization signature repository 306. If sufficient correspondence with known signatures in the repository 306 is identified, appropriate alarm conditions are initiated within a network management alarm system 310 for the optical network.

According to some embodiments, there is also employed a Temporal Trend Analysis Module which recognizes evolving scenarios allowing for early warning capabilities when patterns begin to match the initial stages of known threat progressions. Some of these embodiments provide confidence scoring to prioritize potential matches for operator attention.

This is accomplished by using temporal trend analysis using:
Sequence analysis algorithms to recognize pattern progressions that indicate worsening conditions;
Trend detection algorithms to track multiple metrics simultaneously (frequency, intensity, duration);
Early warning indicators to identify initial pattern characteristics that typically precede serious disruptions; and
Multivariate trend analysis to capture complex pattern evolution over time.

According to yet other embodiments, there may also be employed a network-wide correlation framework which integrates data from multiple sample monitoring points using knowledge of the network topology.

This is accomplished using:
Light-speed delay analysis to account for propagation delays between monitoring points when correlating events;
Differential pattern analysis to compare characteristics between nearby vs. distant switches;
Signal strength triangulation using the relative intensity of patterns at different switches;
Timing-based approaches analyzing arrival time differences of pattern onsets; and
Implementing sophisticated propagation models that account for how polarization changes travel through the fiber, allowing for accurate localization even with limited monitoring points.

With respect to the polarization signature repository 306, a number of techniques may be used to stock the repository. Some data-efficient pattern learning and matching techniques may be applied to make reliable inferences even when conventional deep learning techniques would fail due to data scarcity.

This may be accomplished via use of:
Bayesian Methods which enable statistical inference even with small sample sizes including:
   Gaussian Processes for time-series modeling with uncertainty quantification;
   Bayesian networks to incorporate prior knowledge and learn from small datasets; and
   Probabilistic programming approaches that express uncertainty appropriately.
One-Shot/Few-Shot Learning Adaptations which enable recognition of new pattern types with as few as 1-5 examples including:
   Siamese networks that compare new patterns to known exemplars;
   Prototypical networks that can learn from very few examples per class; and
   Metric learning approaches that focus on learning similarity functions rather than complex classifiers.
Knowledge-Based Feature Engineering which requires less data than automated feature learning approaches:
   Using the physics of fiber optics to identify meaningful features;
   Calculation of domain-specific metrics that are known to respond to certain disturbance types; and
   Reducing dimensionality based on expert knowledge rather than data-driven approaches.

There is further contemplated use of a transfer learning and simulation framework which further overcomes the limited data challenge by:
Creating high-fidelity physical simulations of polarization effects for different disturbance types;
   Training initial models on abundant simulated data generated from first principles of optical physics;
   Fine-tuning these pre-trained models with the limited real-world data; and
   Implementing domain adaptation techniques to bridge the gap between simulation and reality.

In conjunction with the data-efficient pattern learning and matching techniques, embodiments may employ a hybrid model architecture for limited data scenarios which addresses the challenge of limited historical data through a novel hybrid architecture and ensures the monitoring system can provide value immediately, even before sufficient historical data has been collected for conventional machine learning approaches.

This is accomplished by:
Using physics-informed signal processing rather than pure deep learning approaches;
Using domain knowledge to identify key features (wavelet coefficients, geometric properties) that don't require large training sets;
Implementing rule-based detection for well-understood pattern types;
Selectively incorporating machine learning only for specific tasks where sufficient data exists; and

Combining analytical models with data-driven components in a unified framework.

According to another embodiment, the application of incremental learning strategy with active human feedback can be used for building the signature repository 306, which makes efficient use of expert time while continuously improving the system by:
Commencing with simple, reliable pattern detection based on signal processing;
Building a basic library of patterns as they're discovered and verified;
Initially using similarity-based matching rather than classification;
Incorporating more sophisticated learning methods as data accumulates;
Prioritizing uncertain patterns for human verification to maximize learning efficiency;
Implementing a system where human experts classify only the most informative patterns; and
Building confidence scores to indicate when the system should rely on automated vs. human classification.

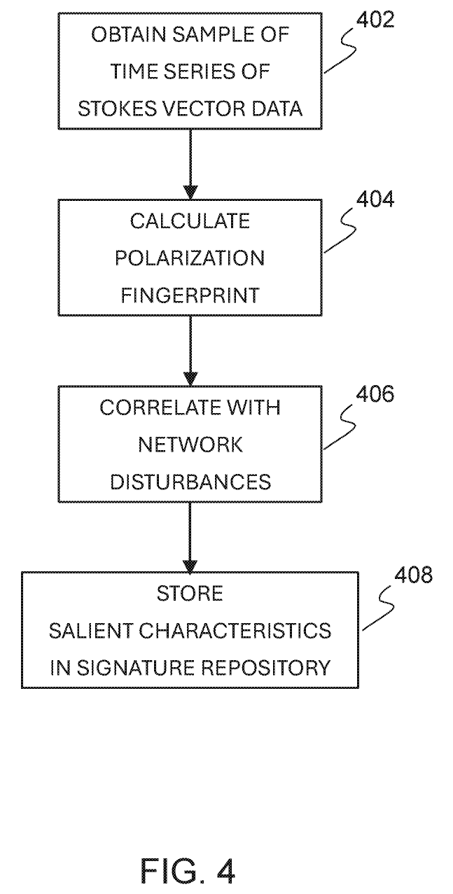

Referring now to FIG. 4, there may be seen a flowchart of a method for stocking the polarization signature repository 306 of FIG. 3 according to an embodiment of the disclosure.

The method commences with step 402, wherein an appropriate time-series sample of Stokes vector data is obtained. Next, at step 404 a polarization fingerprint representative of the time-series data is calculated. Next, at step 406, this polarization fingerprint is correlated with network disturbances using analysis techniques described previously. Subsequently, at step 408, salient characteristics of the polarization signature and related network disturbances are stored in the signature repository 306 for future reference.

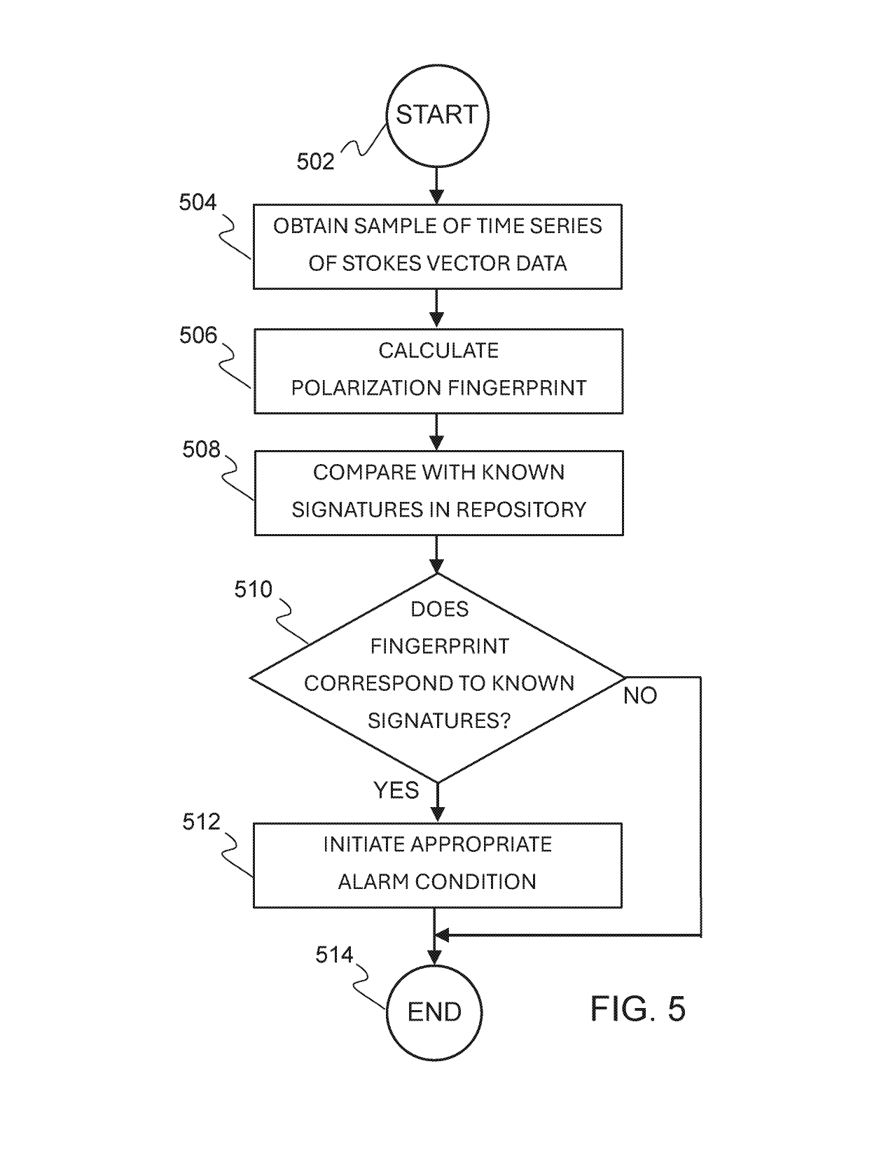

Referring now to FIG. 5, there may be seen a flowchart of a method for providing early warnings of developing problems in fiber optic systems according to an embodiment of the disclosure.

The method commences at step 502. At step 504, a time-series sample of Stokes vector data is obtained at a particular optical network sample point. At step 506, a polarization fingerprint representative of the trajectory traced by the polarization states of the time-series is calculated. At step 508, the calculated polarization fingerprint is compared with known trajectory signatures stored in a signature repository (such as polarization signal repository 306 in FIG. 3). At step 510, a comparison function assesses whether the calculated polarization fingerprint sufficiently corresponds to known problem signatures. In the event that the answer is “yes”, that it does sufficiently correspond, then, at step 512, the method initiates an alarm condition appropriate to the identified known or anticipated problem. In the event that the answer to step 510 is “no”, the method skips the step of initiating an alarm condition and ends at step 514.

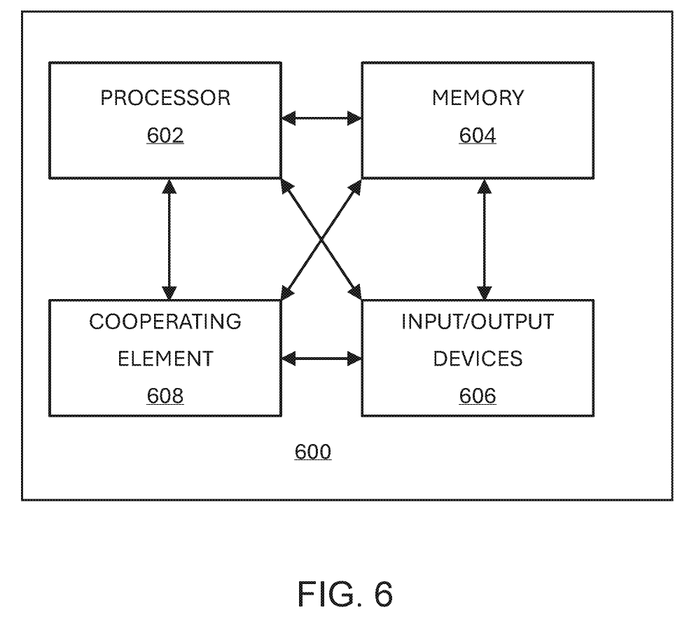

FIG. 6 depicts an example embodiment of a computer suitable for use in performing various functions presented herein.

The computer 600 includes a processor 602 (e.g., a processing unit such as a CPU(s), a GPU(s), an NPU(s), or the like) and a memory 604 (e.g., a random access memory (RAM), a read-only memory (ROM), or the like). In at least some example embodiments, the computer 600 may include at least one processor 602 and at least one memory 604 storing instructions that, when executed by the at least one processor 602, cause the computer 600 to perform various functions presented herein.

The computer 600 may also include a cooperating element 608. The cooperating element 608 may include hardware or a hardware device. The cooperating element 608 may also include firmware. The cooperating element 608 may include software, such as a process that can be loaded into the memory 604 and executed by the processor 602 to implement various functions presented herein (in which case, for example, the cooperating element 608 (including associated data structures) can be stored on a non-transitory computer readable medium, such as a storage device or other suitable type of storage element (e.g., a magnetic drive, an optical drive, or the like)).

The computer 600 may also include one or more input/output devices 606. The input/output devices 606 may include one or more of a user input device (e.g., a keyboard, a keypad, a mouse, a microphone, a camera, or the like), a user output device (e.g., a display, a speaker, or the like), one or more network communication devices or elements (e.g., an input port, an output port, a receiver, a transmitter, a transceiver, or the like), one or more storage devices (e.g., a tape drive, a floppy drive, a hard disk drive, a compact disk drive, or the like), or the like, as well as various combinations thereof.

It will be appreciated that computer 600 may represent a general architecture and functionality suitable for implementing functional elements described herein, portions of functional elements described herein, or the like, as well as various combinations thereof. For example, computer 600 may provide a general architecture and functionality that is suitable for implementing utilizing a processing unit as presented herein, a portion of a processing unit as presented herein (e.g., a processor core, a core management entity, or the like), or the like as well as various combinations thereof. .

Accordingly, embodiments have been disclosed that address several specific technical problems in optical network monitoring including:
The failure of existing monitoring systems to detect early warning signs of potential fiber disturbances, resulting in reactive rather than preventative maintenance;
Struggles associated with current systems to precisely localize disturbances, especially in complex network topologies with limited monitoring points;
The lack of sophisticated signal processing techniques to extract meaningful patterns from this complex four-dimensional data (S0, S1, S2, S3) in existing systems, even though telecom switches can measure Stokes vectors;
The inability of existing monitoring systems to effectively differentiate between different types of disturbances (e.g., construction activities versus environmental factors) based solely on optical data without additional sensors;
The lack of an effective framework for cataloging and matching patterns to identify recurring or progressive disturbances across the network in existing systems;
The requirement of large deviations to trigger alerts in traditional monitoring, making existing systems miss subtle changes that precede major disruptions; Current systems failure to capture the temporal evolution of disturbances, causing them to miss critical information about whether threats are increasing or decreasing in severity over time; and

The challenges associated with the limited historical data on pattern types in current systems for building effective pattern recognition systems, as conventional machine learning approaches require large training datasets that are not initially available in this domain.

Numerous modifications, variations and adaptations may be made to the particular embodiments of the disclosure described above without departing from the scope of the disclosure, which is defined in the claims.

Unless explicitly stated otherwise, each numerical value and range should be interpreted as being approximate as if the word “about” or “approximately” preceded the value or range.

Although the elements in the following method claims are recited in a particular sequence with corresponding labeling, unless the claim recitations otherwise imply a particular sequence for implementing some or all of those elements, those elements are not necessarily intended to be limited to being implemented in that particular sequence. Likewise, additional steps may be included in such methods, and certain steps may be omitted or combined, in methods consistent with various embodiments of the disclosure.

Reference herein to “one embodiment” or “an embodiment” means that a particular feature, structure, or characteristic described in connection with the embodiment can be included in at least one embodiment of the disclosure. The appearances of the phrase “in one embodiment” in various places in the specification are not necessarily all referring to the same embodiment, nor are separate or alternative embodiments necessarily mutually exclusive of other embodiments. The same applies to the term “implementation.”

Unless otherwise specified herein, the use of the ordinal adjectives “first,” “second,” “third,” etc., to refer to an object of a plurality of like objects merely indicates that different instances of such like objects are being referred to, and is not intended to imply that the like objects so referred-to have to be in a corresponding order or sequence, either temporally, spatially, in ranking, or in any other manner.

Also, for purposes of this description, the terms “couple,” “coupling,” “coupled,” “connect,” “connecting,” or “connected” refer to any manner known in the art or later developed in which energy is allowed to be transferred between two or more elements, and the interposition of one or more additional elements is contemplated, although not required. Conversely, the terms “directly coupled,” “directly connected,” etc., imply the absence of such additional elements. The same type of distinction applies to the use of terms “attached” and “directly attached,” as applied to a description of a physical structure.

As used herein in reference to an element and a standard, the terms "compatible" and “conform” mean that the element communicates with other elements in a manner wholly or partially specified by the standard and would be recognized by other elements as sufficiently capable of communicating with the other elements in the manner specified by the standard. A compatible or conforming element does not need to operate internally in a manner specified by the standard.

The described embodiments are to be considered in all respects as only illustrative and not restrictive. In particular, the scope of the disclosure is indicated by the appended claims rather than by the description and figures herein. All changes that come within the meaning and range of equivalency of the claims are to be embraced within their scope.

The functions of the various elements shown in the figures, including any functional blocks labeled as “processors” and/or “controllers,” may be provided through the use of dedicated hardware as well as hardware capable of executing software in association with appropriate software. Upon being provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read only memory (ROM) for storing software, random access memory (RAM), and non-volatile storage. Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

It should be appreciated by those of ordinary skill in the art that any block diagrams herein represent conceptual views of illustrative circuitry embodying the principles of the disclosure. Similarly, it will be appreciated that any flow charts, flow diagrams, state transition diagrams, pseudo code, and the like represent various processes which may be substantially represented in computer readable medium and so executed by a computer or processor, whether or not such computer or processor is explicitly shown.

As will be appreciated by one of ordinary skill in the art, the present disclosure may be embodied as an apparatus (including, for example, a system, a network, a machine, a device, a computer program product, and/or the like), as a method (including, for example, a business process, a computer-implemented process, and/or the like), or as any combination of the foregoing. Accordingly, embodiments of the present disclosure may take the form of an entirely software-based embodiment (including firmware, resident software, micro-code, and the like), an entirely hardware embodiment, or an embodiment combining software and hardware aspects that may generally be referred to herein as a "system" or “network”.

Embodiments of the disclosure can be manifest in the form of methods and apparatuses for practicing those methods. Embodiments of the disclosure can also be manifest in the form of program code embodied in tangible media, such as magnetic recording media, optical recording media, solid state memory, floppy diskettes, CD-ROMs, hard drives, or any other non-transitory machine-readable storage medium, wherein, upon the program code being loaded into and executed by a machine, such as a computer, the machine becomes an apparatus for practicing the disclosure. Embodiments of the disclosure can also be manifest in the form of program code, for example, stored in a non-transitory machine-readable storage medium including being loaded into and/or executed by a machine, wherein, upon the program code being loaded into and executed by a machine, such as a computer, the machine becomes an apparatus for practicing the disclosure. Upon being implemented on a general-purpose processor, the program code segments combine with the processor to provide a unique device that operates analogously to specific logic circuits. The term “non-transitory,” as used herein, is a limitation of the medium itself (i.e., tangible, not a signal) as opposed to a limitation on data storage persistency (e.g., RAM vs. ROM).

In this specification including any claims, the term "each" may be used to refer to one or more specified characteristics of a plurality of previously recited elements or steps. When used with the open-ended term "comprising," the recitation of the term "each" does not exclude additional, unrecited elements or steps. Thus, it will be understood that an apparatus may have additional, unrecited elements and a method may have additional, unrecited steps, where the additional, unrecited elements or steps do not have the one or more specified characteristics.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements. For example, the phrases “at least one of A and B” and “at least one of A or B” are both to be interpreted to have the same meaning, encompassing the following three possibilities: 1- only A; 2- only B; 3- both A and B.

As used herein and in the claims, the term “provide” with respect to an apparatus or with respect to a system, device, or component encompasses designing or fabricating the apparatus, system, device, or component; causing the apparatus, system, device, or component to be designed or fabricated; and/or obtaining the apparatus, system, device, or component by purchase, lease, rental, or other contractual arrangement.

While preferred embodiments of the disclosure have been shown and described herein, it will be obvious to those skilled in the art that such embodiments are provided by way of example only. Numerous variations, changes, and substitutions will now occur to those skilled in the art without departing from the disclosure. It should be understood that various alternatives to the embodiments of the disclosure described herein may be employed in practicing the technology of the disclosure. It is intended that the following claims define the scope of the disclosure and that methods and structures within the scope of these claims and their equivalents be covered thereby.

What is claimed is:

1. A method for pattern and trend identification in fiber sensing in an optical network comprising:
obtaining a sample of a recent time-series of Stokes vector data from a subset of collection points in the optical network;
determining a respective polarization signature from the time-series of Stokes vector data;
comparing the polarization signature to known disturbance polarization signatures in a polarization signature repository; and
raising an alarm when the polarization signature sufficiently corresponds to a known disturbance polarization signature in the repository.

2. The method of claim 1, wherein
the subset of collection points corresponds to a single sampling point in the optical network.

3. The method of claim 1, wherein
the polarization signature comprises a time-series trajectory of the recent time-series of Stokes vector data; and
the determining step uses geometric properties of the time-series trajectory to form a polarization fingerprint of the recent time-series of Stokes vector data.

4. The method of claim 3, wherein
the disturbance polarization signatures in the repository each comprise a known disturbance polarization fingerprint that corresponds to a unique known network disturbance; and
the comparing step compares the polarization fingerprint to the known disturbance polarization fingerprints corresponding to the disturbance polarization signatures in the repository.

5. The method of claim 4, wherein
the geometric properties of the time-series trajectory comprise at least one of arc length, curvature, and torsion.

6. The method of claim 1, wherein
the comparing step further comprises using multi-resolution signal processing to detect correspondence between the polarization signature and the disturbance polarization signatures in the repository.

7. The method of claim 6, wherein
the multi-resolution signal processing comprises at least of one wavelet transform analysis, non-linear dynamics analysis, and information-theoretic measure assessment.

8. The method of claim 1, wherein
the comparing step uses temporal-trend analysis processing.

9. The method of claim 8, wherein
the temporal-trend analysis processing comprises at least of one of sequence analysis methods, trend detection methods, early warning indicator methods, and multivariate trend analysis.

10. The method of claim 1, wherein
the subset of collection points comprises multiple monitoring points within the optical network, with each collection point having a respective obtained sample of a recent time-series of Stokes vector data.

11. The method of claim 10, wherein
the determining step further comprises determining respective polarization signatures for each of the respective obtained samples of recent time-series of Stokes vector data; and
wherein the method further comprises correlating the respective polarization signatures to generate a composite polarization signature representative of disturbances of the optical network over more than one sample point.

12. The method of claim 11, wherein
the correlating step comprises at least one of light-speed delay analysis, differential pattern analysis, signal strength triangulation, timing-based analysis, and propagation models analysis.

13. The method of claim 1, wherein
the known disturbance polarization signatures further comprise known disturbance precursor indicators indicative of a potential optical network disturbance; and
wherein the method further comprises stocking the repository with the known disturbance polarization signatures, the known disturbance polarization signatures being obtained by a pattern learning and matching system.

14. The method of claim 13, wherein
the stocking step further comprises application of at least one of Bayesian methods, one-shot/few-shot learning adaptation methods, and knowledge-based feature engineering methods.

15. The method of claim 14, wherein
the stocking step further comprises application of at least one of using physics-informed signal processing, using domain knowledge, implementing rule-based detection for well-understood pattern types, selectively incorporating machine learning, and combining analytical models with data-driven components.

16. The method of claim 13, wherein
the stocking step further comprises application of at least one of using physics-informed signal processing, using high-fidelity physical simulations of polarization effects for different disturbance types, training initial models on simulated data, fine-tuning pre-trained models with available real-world data, and using domain adaptation techniques improve the known disturbance polarization signatures.

17. A disturbance alerting manager for pattern and trend identification in fiber sensing in an optical network comprising:
at least one processor; and at least one memory storing instructions that, upon being executed by the at least one processor, cause the disturbance alerting manager at least to:
obtain a sample of a recent time-series of Stokes vector data from a subset of collection points in the optical network;
determine a polarization signature from the time-series of Stokes vector data;
compare the polarization signature to known disturbance polarization signatures in a polarization signature repository; and
raise an alarm when the polarization signature sufficiently matches a known disturbance polarization signature from the repository.

18. The disturbance alerting manager of claim 17, wherein
the subset of collection points corresponds to a single sampling point in the optical network.

19. The disturbance alerting manager of claim 17, wherein
the known disturbance polarization signatures further comprise known disturbance precursor indicators indicative of a potential optical network disturbance; and
wherein the repository is stocked with the known disturbance polarization signatures, the known disturbance polarization signatures being obtained by a pattern learning and matching system.

20. The disturbance alerting manager of claim 17, wherein
the known disturbance polarization signatures in the repository each comprise a known disturbance polarization fingerprint that corresponds to a unique known network disturbance;
wherein the polarization fingerprint is compared to the known disturbance polarization fingerprints corresponding to the disturbance polarization signatures in the repository; and
wherein raising the alarm when the polarization signature sufficiently matches a known disturbance polarization fingerprint further comprises providing alarm information indicative of the unique known network disturbance of the matched disturbance polarization fingerprint.
